(19) United States
(12) Patent Application Publication
(10) Pub. No.: US 2006/0147252 A1
(43) Pub. Date: Jul. 6, 2006

(54) Liquid graphite pencil

(76) Inventor: Kathleen Torrell, Playa del Rey, CA (US)

Correspondence Address: TOPE-MCKAY & ASSOCIATES, 23852 PACIFIC COAST HIGHWAY #311, MALIBU, CA, 90265, US

(21) Appl. No.: 11/029,174

(22) Filed: Jan. 3, 2005

(51) Int. Cl. B43K 25/00

(52) U.S. Cl. 401/209

(57) ABSTRACT

A liquid graphite pencil is presented, and more particularly a wooden pencil that includes a liquid graphite cartridge disposed therein. The liquid graphite pencil includes a plurality of shell portions with grooves. A liquid graphite cartridge is placed within the grooves and enclosed with an adhesive between the plurality of shell portions. A ball point tip is connected with the cartridge, allowing a user to release the liquid graphite and write with the pencil. A cap with an eraser is connected with the plurality of shell portions, permitting a user to erase previously written graphite.

### BACKGROUND OF THE INVENTION

(1) Technical Field

The present invention is directed to a pencil, and more particularly to a pencil that includes a cartridge with a ball point tip for dispensing liquid graphite.

(2) Description of Related Art

Pencils have been made of an elongated graphite core encased between two halves of wood. The two halves are generally cut (e.g., grooved out) to accommodate the graphite core. After having grooved out the two halves, glue or another adhesive is applied to the two halves, with the graphite core thereafter placed within the groove. The two halves are then brought together to sandwich the graphite core, thereby forming the pencil.

Although functional, problems are associated with typical pencils. Pencils require constant sharpening where, after being dulled, they must be re-sharpened. Additionally, the graphite core is subject to breaking. In some circumstances, when the graphite core breaks, the pencil becomes virtually useless with the graphite simply falling out of the pencil.

As an alternative to a pencil, an ink pen may be used. An ink pen generally comprises an elongated barrel with an ink cartridge and a ball point tip. Although an ink pen does need to be sharpened and does not break, it does have some inherent drawbacks. For example, when applied to paper, ink is subject to smearing and bleeding. Additionally, because the ink is absorbed into the fibers of writing paper, most inks are non-erasable.

To overcome problems associated with ink and to gain the benefits of graphite pencils, a form of liquid graphite has been devised. U.S. Pat. Nos. 2,715,388; 2,852,397; 2,956,038, issued to Cofield et al., Goessling, and Juelss et al. respectively, disclose forms of liquid graphite. Although having properties somewhat similar to a typical graphite core, the liquid graphite has never been included in wooden pencils, and thus has never received the benefits of pencils (e.g., ease of formation, rigidity, and natural wood appearance).

Accordingly, a need exists for a pencil that includes the benefits of liquid graphite, thus providing a user with the rigidity and aesthetic benefits of a typical wooden pencil.

### SUMMARY OF THE INVENTION

The present invention relates to a liquid graphite pencil. The liquid graphite pencil comprises a plurality of shell portions, where each shell portion includes a length with a proximal end and a distal end. A groove portion is formed along at least a portion of the length of the shell portion. A liquid graphite cartridge is substantially enclosed within the groove portions. The liquid graphite cartridge has a fluid therein and a writing end. The liquid graphite cartridge is enclosed such that the shell portions and the graphite cartridge are connected to form a pencil body, with the graphite portion residing substantially within the pencil body, with the writing end of the graphite cartridge extending from the pencil body. A user may grip the pencil body and place the writing end of the graphite cartridge against a writing surface to write thereon.

In another aspect, the present invention also comprises a cap covering the proximal ends of the plurality of shell portions; and an eraser connected with the cap. The eraser is functional for erasing the fluid after the fluid has been disposed upon a writing surface.

Additionally, the plurality of shell portions include at least two shell portions, a first shell portion and a second shell portion.

The present invention further comprises an adhesive disposed between the plurality of shell portions and the liquid graphite cartridge, the adhesive functioning to maintain connections between the plurality of shell portions and cartridge.

In yet another aspect, the plurality of shell portions are connected to form the pencil body, with the pencil body having a six-sided pencil shape.

In another aspect, the writing end of the liquid graphite cartridge includes a fluid dispenser, with the fluid dispenser extending beyond the distal ends of the plurality of shell portions.

In another aspect, the fluid is liquid graphite.

Additionally, the plurality of shell portions are formed of wood.

In yet another aspect, the eraser is removably connected with the cap, such that a user may selectively attach and detach the eraser from the cap.

Furthermore, the fluid dispenser is a ball-point tip.

The present invention also includes a method for forming a liquid graphite pencil. The method comprises acts of: forming a groove portion in a plurality of shell portions, where each shell portion includes a length with a proximal end and a distal end, and the groove portion is along at least a portion of the length of the shell portion; and enclosing a liquid graphite cartridge having a writing end and a fluid therein, within the groove portions of the plurality of shell portions, the liquid graphite cartridge substantially enclosed within the groove portions of the plurality of shell portions such that the shell portions and the graphite cartridge are connected to form a pencil body with the graphite portion residing substantially within the pencil body, with the writing end of the graphite cartridge extending from the pencil body, whereby a user may grip the pencil body and place the writing end of the graphite cartridge against a writing surface to write thereon.

In another aspect, the present invention further comprises acts of covering the proximal ends of the plurality of shell portions with a cap; and connecting an eraser with the cap, the eraser being functional for erasing the fluid after the fluid has been disposed upon a writing surface.

In yet another aspect, the present invention further comprises an act of forming the cap such that the eraser is removably connected with the cap, where a user may selectively attach and detach the eraser from the cap.

Additionally, in the act of forming a groove portion in a plurality of shell portions, the plurality of shell portions include at least two shell portions, a first shell portion and a second shell portion.

In yet another aspect, the present invention further comprises an act of disposing an adhesive between the plurality of shell portions and the liquid graphite cartridge, the adhesive functioning to maintain connections between the plurality of shell portions and cartridge.

Furthermore, in the act of enclosing a liquid graphite cartridge, the plurality of shell portions are connected to form the pencil body, with the pencil body having a six-sided pencil shape.

Additionally, in the act of enclosing a liquid graphite cartridge, the writing end of the liquid graphite cartridge includes a fluid dispenser, the fluid dispenser extending beyond the distal ends of the plurality of shell portions.

In yet another aspect, in the act of enclosing a liquid graphite cartridge, the fluid dispenser is a ball point tip.

Finally, in the act of forming a groove portion in a plurality of shell portions, the plurality of shell portions are formed of wood.

### BRIEF DESCRIPTION OF THE DRAWINGS

The objects, features and advantages of the present invention will be apparent from the following detailed descriptions of the various aspects of the invention in conjunction with reference to the following drawings where:

FIG. 1 is an illustration of an assembled liquid graphite pencil according to the present invention;

FIG. 2 is an illustration of an unassembled liquid graphite pencil according to the present invention;

FIG. 3A is an illustration depicting a cross-sectional view of a liquid graphite pencil according to the present invention, taken from line III-III of FIG. 1; and

FIG. 3B is an illustration depicting a cross-sectional view of a liquid graphite pencil according to the present invention, illustrating assemblage of the pencil shown in FIG. 3A.

### DETAILED DESCRIPTION

The present invention is directed to a pencil, and more particularly to a pencil that includes a cartridge with a ball point tip for dispensing liquid graphite.

The following description, taken in conjunction with the referenced drawings, is presented to enable one of ordinary skill in the art to make and use the invention. Various modifications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

In the following detailed description, numerous specific details are set forth in order to provide a more thorough understanding of the present invention. However, it will be apparent to one skilled in the art that the present invention may be practiced without necessarily being limited to these specific details.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first an introduction is provided to provide the reader with a general understanding of the present invention. Second, a description of various aspects of the present invention is provided to give an understanding of the specific details.

(1) Introduction

The present invention relates to a pencil. Pencils have long been known in the art and typically include two wooden halves with a graphite core encased between the two halves. The use of graphite provides several benefits. For example, the graphite does not smear as readily as wet ink. Additionally, the graphite is not absorbed into the writing paper, preventing bleeding and allowing it to be erasable. The problem with such pencils however is that the graphite core requires constant sharpening and is subject to breakage.

To overcome shortcomings of traditional pencils, the present invention combines two wooden halves encasing a liquid graphite cartridge and a ball-point tip for dispensing liquid graphite. The liquid graphite provides the pencil with the benefits of a traditional graphite core, with none of the drawbacks.

(2) Detailed Description

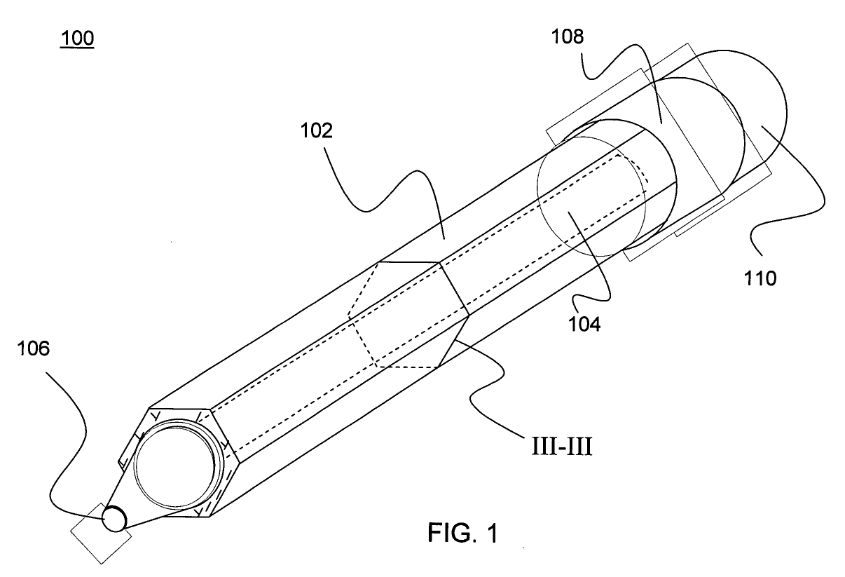

FIG. 1 illustrates an assembled liquid graphite pencil 100 according to the present invention. The pencil 100 includes a plurality of shell portions 102 encasing a liquid graphite cartridge 104 to form the pencil 100 body. The pencil 100 body can be formed in several shapes, a non-limiting example of which includes having six sides. Additionally, the plurality of shell portions 102 can be formed of a variety of materials, non-limiting examples of which include wood, plastic, and metal. It is desirable that wood is used because of its ease of construction, rigidity, and natural feel. As can be appreciated by one in the art, the cartridge 104 is an elongated tube filled with a fluid, such as liquid graphite. Liquid graphite has been described in a variety of applications and forms. It can come in the form of a powder or liquid. Essentially, liquid graphite is a fluid that contains a sufficient amount of graphite, or similar marking substance to mark a writing surface, yet possesses erasable properties.

Attached with a writing end of the liquid graphite cartridge 104 is a fluid dispenser 106. The fluid dispenser 106 is a mechanism or device that allows the liquid graphite to be drawn from the cartridge 104 to be deposited on a writing surface, a non-limiting example of which includes a ball point tip. A cap 108 connected with the plurality of shell portions 102 such that it covers an end of the plurality of shell portions 102. The cap 108 can be a traditional metal tubular cap that slides over the end of the shell, with a hole therein for inclusion of an eraser 110. Alternatively, the cap 108 can be a plastic cap that covers the end of the shell portions 102. Additionally, the eraser 110 can be attached with the cap 108. The eraser 110 can be either permanently affixed with the cap 108, or removably connected with the cap 108. When removably connected, a user may selectively attach and detach the eraser 110 from the cap 108.

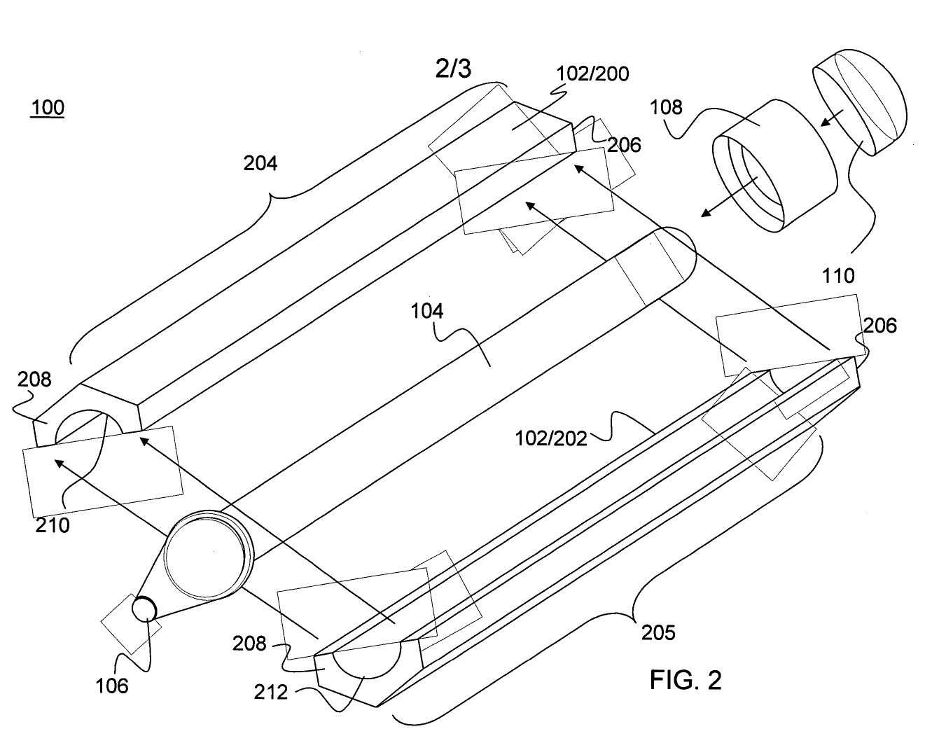

FIG. 2 illustrates an unassembled liquid graphite pencil 100. As shown in FIG. 2, the plurality of shell portions 102 are formed of at least two shell portions, such as a first shell portion 200 and a second shell portion 202. Each of the first shell portion 200 and the second shell portion 202 have lengths 204 and 205 respectively, with both a proximal 206 and distal end 208. Grooves are formed in both the first shell portion 200 and the second shell portion 202, with the first shell portion 200 having a first groove 210 and the second shell portion 202 having a second groove 212. The grooves 210 and 212, run the lengths 204 and 205 of the shells between the proximal 206 and distal 208 ends. The grooves 210 and 212, are formed such that they accommodate the cartridge 104, allowing the cartridge 104 to be disposed within the grooves 210 and 212. The cartridge 104 is positioned within the grooves 210 and 212, such that the fluid dispenser 106 extends beyond the distal ends 208 of both the first shell portion 200 and the second shell portion 202.

After the cartridge 104 is enclosed between the first shell portion 200 and the second shell portion 202, the cap 108 may be affixed with the shell 102. The cap 108 is attached such that it covers the proximal end 206 of the shell 102. As shown in FIG. 2, and as previously discussed, the eraser 110 may be attached with the cap 108.

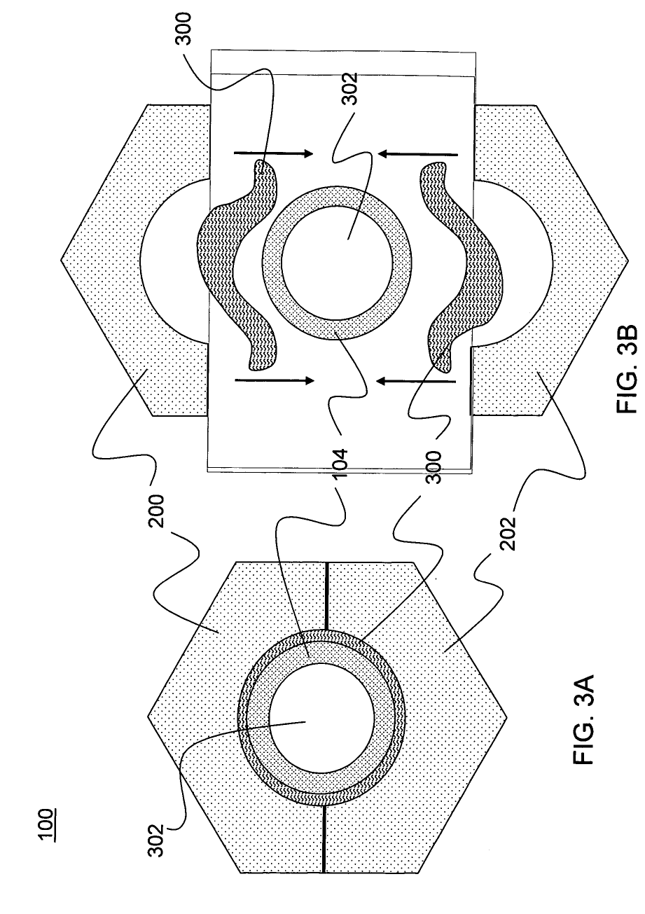

FIG. 3A illustrates a liquid graphite pencil 100, taken from line III-III of FIG. 1. As shown in FIG. 3A, the first shell portion 200 and second shell portion 202 encase the cartridge 104 with its core of liquid graphite 302. An adhesive 300 is disposed between all of the first shell portion 200, the second shell portion 202, and the cartridge 104. The adhesive 300 functions to maintain the connections between the first shell portion 200, the second shell portion 202, and the cartridge 104. The adhesive 300 is a suitable solution with adhesive properties, a non-limiting example of which includes glue.

FIG. 3B illustrates assembly of the pencil 100 shown in FIG. 3A. As shown, the adhesive 300 is applied to both the first 200 and second 202 shells, with the cartridge 104 encased therebetween. After the shells are pressed together, the adhesive 300 is allowed to set, after which the pencil 100 may receive further processing. For example, the pencil 100 can be sanded and painted. After all processing has been completed, a user may utilize the pencil 100 to release the liquid graphite 302 and write upon a writing surface.

Although not shown, but as can be appreciated by one in the art, there are several techniques to secure the liquid graphite cartridge within the plurality of shell portions. As a non-limiting example, the plurality of shell portions can be plastic welded with the liquid cartridge encased therein. As another non-limiting example, the plurality of shell portions can be formed with grooves for sliding one shell portion into another. As a final example, the shell portions can be formed such that they can be snapped together.

What is claimed is:

1. A liquid graphite pencil, comprising:
a plurality of shell portions, where each shell portion includes a length with a proximal end and a distal end, and a groove portion along at least a portion of the length of the shell portion;
a liquid graphite cartridge having a fluid therein and a writing end, the liquid graphite cartridge substantially enclosed within the groove portions of the plurality of shell portions such that the shell portions and the graphite cartridge are connected to form a pencil body with the graphite portion residing substantially within the pencil body, with the writing end of the graphite cartridge extending from the pencil body, whereby a user may grip the pencil body and place the writing end of the graphite cartridge against a writing surface to write thereon.

2. A liquid graphite pencil as set forth in claim 1, further comprising:
a cap covering the proximal ends of the plurality of shell portions; and
an eraser connected with the cap, the eraser being functional for erasing the fluid after the fluid has been disposed upon a writing surface.

3. A liquid graphite pencil as set forth in claim 2, wherein the plurality of shell portions include at least two shell portions, a first shell portion and a second shell portion.

4. A liquid graphite pencil as set forth in claim 3, further comprising an adhesive disposed between the plurality of shell portions and the liquid graphite cartridge, the adhesive functioning to maintain connections between the plurality of shell portions and cartridge.

5. A liquid graphite pencil, as set forth in claim 4, wherein the plurality of shell portions are connected to form the pencil body, with the pencil body having a six-sided pencil shape.

6. A liquid graphite pencil as set forth in claim 5, wherein the writing end of the liquid graphite cartridge includes a fluid dispenser, the fluid dispenser extending beyond the distal ends of the plurality of shell portions.

7. A liquid graphite pencil, as set forth in claim 6, wherein the plurality of shell portions are formed of wood.

8. A liquid graphite pencil, as set forth in claim 7, wherein the eraser is removably connected with the cap, such that a user may selectively attach and detach the eraser from the cap.

9. A liquid graphite pencil, as set forth in claim 8, wherein the fluid dispenser is a ball point tip.

10. A liquid graphite pencil, as set forth in claim 2, wherein the eraser is removably connected with the cap, such that a user may selectively attach and detach the eraser from the cap.

11. A liquid graphite pencil as set forth in claim 1, wherein the plurality of shell portions include at least two shell portions, a first shell portion and a second shell portion.

12. A liquid graphite pencil as set forth in claim 1, further comprising an adhesive disposed between the plurality of shell portions and the liquid graphite cartridge, the adhesive functioning to maintain connections between the plurality of shell portions and cartridge.

13. A liquid graphite pencil, as set forth in claim 1, wherein the plurality of shell portions are connected to form the pencil body, with the pencil body having a six-sided pencil shape.

14. A liquid graphite pencil as set forth in claim 1, wherein the writing end of the liquid graphite cartridge includes a fluid dispenser, the fluid dispenser extending beyond the distal ends of the plurality of shell portions.

15. A liquid graphite pencil, as set forth in claim 14, wherein the fluid dispenser is a ball point tip.

16. A liquid graphite pencil, as set forth in claim 1, wherein the plurality of shell portions are formed of wood.

17. A method for forming a liquid graphite pencil, the method comprising acts of:
forming a groove portion in a plurality of shell portions, where each shell portion includes a length with a proximal end and a distal end, and the groove portion is along at least a portion of the length of the shell portion;
enclosing a liquid graphite cartridge having a writing end and a fluid therein, within the groove portions of the plurality of shell portions, the liquid graphite cartridge substantially enclosed within the groove portions of the plurality of shell portions such that the shell portions and the graphite cartridge are connected to form a pencil body with the graphite portion residing substantially within the pencil body, with the writing end of the graphite cartridge extending from the pencil body, whereby a user may grip the pencil body and place the writing end of the graphite cartridge against a writing surface to write thereon.

18. A method for forming a liquid graphite pencil as set forth in claim 17, further comprising acts of:
covering the proximal ends of the plurality of shell portions with a cap; and
connecting an eraser with the cap, the eraser being functional for erasing the fluid after the fluid has been disposed upon a writing surface.

19. A method for forming a liquid graphite pencil as set forth in claim 18, further comprising an act of forming the cap such that the eraser is removably connected with the cap, where a user may selectively attach and detach the eraser from the cap.

20. A method for forming a liquid graphite pencil as set forth in claim 17, wherein in the act of forming a groove portion in a plurality of shell portions, the plurality of shell portions include at least two shell portions, a first shell portion and a second shell portion.

21. A method for forming a liquid graphite pencil as set forth in claim 17, further comprising an act of disposing an adhesive between the plurality of shell portions and the liquid graphite cartridge, the adhesive functioning to maintain connections between the plurality of shell portions and cartridge.

22. A method for forming a liquid graphite pencil as set forth in claim 17, wherein in the act of enclosing a liquid graphite cartridge, the plurality of shell portions are connected to form the pencil body, with the pencil body having a six-sided pencil shape.

23. A method for forming a liquid graphite pencil as set forth in claim 17, wherein in the act of enclosing a liquid graphite cartridge, the writing end of the liquid graphite cartridge includes a fluid dispenser, the fluid dispenser extending beyond the distal ends of the plurality of shell portions.

24. A method for forming a liquid graphite pencil as set forth in claim 23, wherein in the act of enclosing a liquid graphite cartridge, the fluid dispenser is a ball point tip.

25. A method for forming a liquid graphite pencil as set forth in claim 17, wherein in the act of forming a groove portion in a plurality of shell portions, the plurality of shell portions are formed of wood.
